(19) United States
(12) Patent Application Publication
(10) Pub. No.: US 2008/0010097 A1
(43) Pub. Date: Jan. 10, 2008

(54) SYSTEM AND METHOD FOR RISK ADJUSTED COST INDEX MEASUREMENTS FOR HEALTH CARE PROVIDERS

(76) Inventors: Laurence C. Williams, McKinney, TX (US); Melissa Jean Phillips, Murphy, TX (US); William Josiah Taylor III, Austin, TX (US); Freda LaVerne Wright, Dallas, TX (US); Donald Wayne Hatfield, Dallas, TX (US)

Correspondence Address: CARR LLP, 670 FOUNDERS SQUARE, 900 JACKSON STREET, DALLAS, TX, 75202, US

(21) Appl. No.: 11/774,466

(22) Filed: Jul. 6, 2007

Related U.S. Application Data
(60) Provisional application No. 60/819,180, filed on Jul. 7, 2006.

(51) Int. Cl. G06Q 40/00; G06Q 10/00

(52) U.S. Cl. 705/4

(57) ABSTRACT

An improved method of evaluating and comparing the cost-effectiveness of healthcare providers across a wide spectrum of specialties and health conditions of their patients. The method includes the steps of determining criteria for determining a provider's relative cost-effectiveness at providing healthcare at a reasonable cost, and then applying those criteria to assign or exclude a provider from a preferred network of healthcare providers that have an established history of providing the same care at a lower cost than other providers.

### RELATED APPLICATIONS

This application relates to, and claims the benefit of the filing date of co-pending U.S. provisional patent application Ser. No. 60/819,180, entitled “SYSTEM AND METHOD FOR RISK ADJUSTED COST INDEX MEASUREMENTS FOR HEALTH CARE PROVIDERS,” filed Jul. 7, 2006, the entire contents of which are incorporated herein by reference for all purposes.

### FIELD OF THE INVENTION

The present disclosure relates generally to determining a risk adjusted cost index measurement for health care providers, and more particularly, to a system and method for evaluating the cost-effectiveness of health care providers within a health insurance network.

### DESCRIPTION OF THE RELATED ART

Healthcare insurance companies provide insurance plans to consumers or employer groups in exchange for compensation. As in every competitive industry, the healthcare insurance companies attempt to offer competitively priced healthcare insurance to their customers, while attempting to make a profit. An integral part of providing competitively priced healthcare insurance is accurately evaluating health care providers. Accordingly, it is advantageous for heath insurance companies to determine the cost-effectiveness of health care providers, and then financially encourage their customers to visit the most cost-effective health care providers. The cost-effectiveness of a health care provider is determined by taking into account the amount of care provided and the expense of the provided care.

Many healthcare insurance companies develop a preferred healthcare provider network, wherein their customers can visit the healthcare providers that are listed within this network. For the healthcare providers to be part of the preferred network they must prove that they are cost-effective providers, meaning that they provide care at a reasonable cost. Healthcare providers want to be a part of the healthcare provider preferred network so that they can provide care to patients that are customers of the healthcare insurance companies. Being a part of the preferred healthcare provider network can enable a healthcare provider to bring in many additional patients.

Evaluating and comparing the cost-effectiveness of healthcare providers in providing healthcare at a reasonable cost is integral to forming the preferred healthcare provider network. However, different providers of equal skill in providing cost-effective, care may have very different costs to the insurance company, owning to their different geographical locations, type of specialty, numbers of procedures performed, the cost of those procedures, the age and health of the different provider's patients, etc. Thus, prior methods of comparing the cost of different providers in providing healthcare services that take into account geographic location, specialty and type of procedure have not been fully successful.

Accordingly, an improved method of accurately evaluating and comparing healthcare providers across a wide spectrum of specialties and health conditions of their patients, to determine which healthcare providers provide care at a reasonable cost would provide a significant advantage over prior art methods. This method could enable healthcare insurance companies to determine criteria for determining a provider's relative cost-effectiveness at providing healthcare at a reasonable cost, and then apply those criteria to assign or exclude a provider from a preferred network of healthcare providers that have an established history of providing the same care at a lower cost than other providers. This can lead to lower costs for the insurance company as well lower insurance premiums for members.

### SUMMARY OF THE INVENTION

In one embodiment, an improved method of evaluating and comparing the cost-effectiveness of healthcare providers across a wide spectrum of specialties and health conditions of their patients is provided, including the steps of determining criteria for determining a provider's relative cost-effectiveness at providing healthcare at a reasonable cost, and then applying those criteria to assign or exclude a provider from a preferred network of healthcare providers that have an established history of providing the same care at a lower cost than other providers.

One embodiment is a method of evaluating the relative cost of a healthcare provider as compared to a other healthcare providers in providing healthcare services to treat a plurality of diagnosed health conditions of varying severities in patients having different health-cost risks comprising the steps of:

for each health condition of said plurality of diagnosed health condition:

inputting data taken from an overall population of providers in an overall geographic area relating to the cost of treating said diagnosed health condition in each of a plurality of patients in a health-cost risk group and having a severity category for said diagnosed health condition, each of said diagnosed health conditions having initiated an episode of care for treating said diagnosed health condition in each of said patients;

trimming said data that do not meet one or more of a set of data quality criteria to arrive at a trimmed data set of qualified episodes of care;

assigning episode of care data for each patient to one of a plurality of health-cost risk groups based upon similarity of the cost of the treatment of the patient to other patients having an episode of care for same diagnosed health condition of the same category of severity;

calculating the total cost of treatment of said diagnosed health condition for all qualified episodes of care for each severity category of said diagnosed health condition in each of said health-cost risk groups;

calculating the total number of qualified episodes of care for said diagnosed health condition for each severity category of said diagnosed health condition in each of said health-cost risk groups;

where the number of qualified episodes of care for a particular combination of health-cost risk group and severity category is less than a predetermined value, combining costs for a sufficient number of adjacent health-cost risk groups together such that said number of qualified episodes of care for a particular severity category is greater than or equal to said predetermined value;

using uncombined costs, or combined costs where such costs have been combined, calculating an average cost per qualified episode of care for each severity category of said diagnosed health condition in each of said health-cost risk groups;

for each health-cost risk group:

totaling the average costs per episode of care for each of the severity categories and

calculating the relative fraction of the total health-cost risk group is represented by each severity category to determine a relative-cost factor;

determining an expected average cost per episode for a subset of said population of providers corresponding to providers of a particular working specialty and in a particular subset of said overall geographic area by:

inputting data for said subset of providers, said data corresponding to the cost of treating a qualified episode of care for patients of that subset of said population of providers, and segregating both number of qualified episodes of care and the total costs of qualified episodes of care into separate categories for each severity category of said diagnosed health condition in each of said health-cost risk groups;

calculating an average cost per qualified episode of care for each severity category of said diagnosed health condition in each of said health-cost risk groups;

multiplying the relative-cost factor for each corresponding severity category of said diagnosed health condition in each of said health-cost risk groups to calculate an expected cost per qualified episode of care for each of said health conditions in each of said severity categories and health-cost risk groups;

for a particular provider in the subset of said overall population of providers, determining a cost-effectiveness ratio for that provider by:

for each health condition diagnosed by that provider, inputting data for said provider corresponding to that provider's cost of treating qualified episodes of care for that provider's patients, segregating both number of qualified episodes of care and the total costs of qualified episodes of care into separate categories for each severity category of said diagnosed health condition in each of said health-cost risk groups;

trimming and combining the data in the same or a comparable manner as accomplished for the overall population of providers in calculating the relative-cost factors;

summing that provider's actual costs for all qualified episodes of care for each of that provider's diagnosed health conditions in each severity category and in each of said health-risk cost groups and dividing by the sum of the corresponding expected cost per qualified episode of care for each of said diagnosed health conditions in each severity category and in each of said health-risk cost groups to compute a provider's RACI; and

when said provider cost-effectiveness ratio is less than or equal to a predetermined value, storing identity information for said provider in a first memory location, and when said provider cost-effectiveness ratio is greater to said predetermined value, not storing identity information for said provider in said first memory location.

### BRIEF DESCRIPTION OF THE DRAWINGS

For a more complete understanding of the present disclosure, and its advantages, references will now be made in the following Detailed Description to the accompanying drawings, in which:

FIG. 1 is a block diagram of a computer system;

FIG. 2A is a diagram illustrating how the severity of an episode can be determined by three factors; severity of the disease (severity), the organ or organs of the patient wherein the medical condition or diagnosis applies (e.g., central nervous, sensory, endocrine, respiratory), and the etiology of the medical condition or diagnosis (e.g., nutritional, metabolic, traumatic);

FIG. 2B is a chart illustrating stage or severity levels for a diagnosis of breast cancer;

FIG. 2C is a chart illustrating severity levels for a diagnosis of appendicitis;

FIG. 3A is a chart illustrating a Relative Risk Score (“RRS”) for a 54 year old male patient and the value of each of his corresponding conditions;

FIG. 3B is a chart illustrating RRSs for three different patients and their corresponding conditions;

FIGS. 4A-B is a table that shows how the Expected Cost of an episode in a specific Episode Group can be determined;

FIG. 5 is a flow chart illustrating the process of determining a Risk Adjusted Cost Index (“RACI”) value for a specific healthcare provider;

FIG. 6A is a bar graph illustrating the actual average cost for patients with breast neoplasm, wherein the patients have varying relative risk and varying severities of the condition;

FIG. 6B is a bar graph illustrating the actual average cost for patients with coronary artery disease, wherein the patients have varying relative risk and varying severities of the condition;

FIG. 6C is a bar graph illustrating the actual average cost for patients with appendicitis, wherein the patients have varying relative risk and varying severities of the condition;

FIG. 6D is a bar graph illustrating the actual average cost for patients with conjuctivitis, wherein the patients have varying relative risk and varying severities of the condition;

FIG. 6E is a bar graph illustrating the actual average cost for patients with colon cancer and/or rectal cancer, wherein the patients have varying relative risk and varying severities of the condition;

FIG. 6F is a bar graph illustrating the actual average cost for patients with breast cancer, wherein the patients have varying relative risk and varying severities of the condition;

FIG. 6G is a bar graph illustrating the actual average cost for patients with a cholecystitis and/or cholelithiasis, wherein the patients have varying relative risk and varying severities of the condition;

FIG. 7 is a bar graph illustrating the difference in RACI values for specific healthcare providers, wherein one RACI value is adjusted using episode group and severity and another RACI value is adjusted using episode group, severity and comorbidity (i.e., patient health-cost risk);

FIG. 8 is a sample summary report that may be supplied to a healthcare provider, wherein the summary report may help the provider determine how his RACI value was determined;

FIGS. 9A-B is a sample detail report that may be used to compare the cost and type of treatment applied to patients within a specific episode group, severity, specialty, rating area and relative risk group;

FIG. 10 is a sample detail report that illustrates the different procedures carried out by a specific healthcare provider for a patient with cholelithiasis and how this provider compares to his peers;

FIG. 11 is a sample detail report that illustrates the different procedures carried out by eligible and not eligible healthcare providers for patients with Diabetes Mellitus and the comparison between these providers; and

FIG. 12 is a bar graph illustrating the average relative risk/episode, the average high stage/episode, and the average cost/episode.

### DETAILED DESCRIPTION

In the following discussion, numerous specific details are set forth to provide a thorough understanding of the present disclosure. However, those skilled in the art will appreciate that the claimed invention may be practiced without such specific details. In other instances, well-known elements have been illustrated in schematic or block diagram form in order not to obscure the present invention in unnecessary detail.

It is further noted that, unless indicated otherwise, all functions described herein can be performed in either hardware or software, or some combination thereof. In a preferred embodiment, however, the functions are performed by a processor, such as a computer or an electronic data processor, in accordance with code, such as computer program code, software, and/or integrated circuits that are coded to perform such functions, unless indicated otherwise. Many of the functions described throughout this disclosure can be performed by specifically designed algorithms provided on a computer-readable medium.

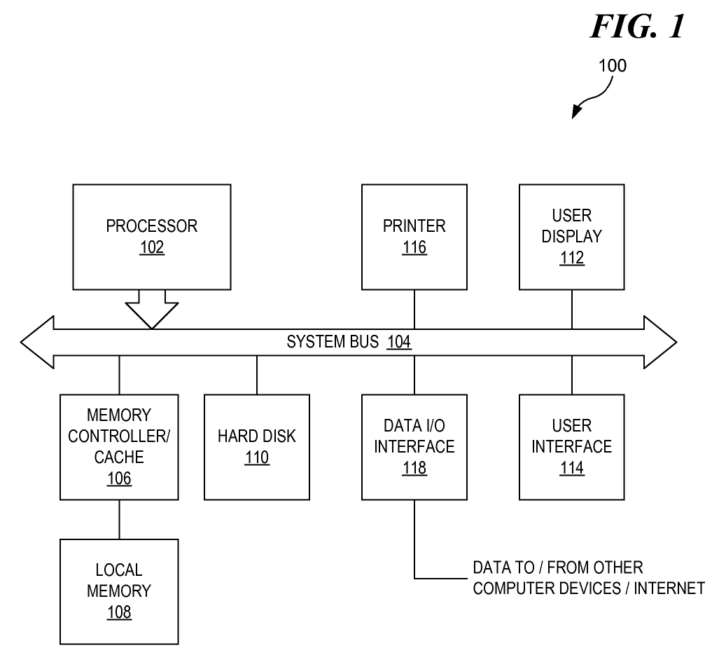

FIG. 1 is a block diagram of a computer system 100. This computer system 100 may be used to perform the functions of the methods described herein. A bus 104 couples the components of the computer system 100, so that the components may transmit data. A processor 102 performs many of the functions of the computer system 100 by manipulating data. A cache memory 106 and a local memory 108 can be used to store data. A user interface 114 enables a user to interact with the computer system 100 by allowing the user to enter commands. The user interface 114 may comprise a mouse, a keyboard, and/or other similar components. A user display 112 enables a user to view the operations of the computer system and the data stored in the computer system. The user display 112 may comprise a monitor and/or other similar components. A hard disk 110 may be used to apply computer software and/or data to the computer system 100 through a computer-readable medium. FIG. 1 is provided as a broad representation of one embodiment of a computer system 100 suitable for evaluating the input data and determining the criteria necessary for evaluating and comparing providers in terms of their cost-effectiveness in providing healthcare. Data interface 118 allows transfer of data relating to the cost-effectiveness of the providers to another data processing system, the internet, a LAN or other devices. This allows the computed data on the cost-effectiveness scores to be sent to the providers or managers in insurance company, for example, to advise them of the cost-effectiveness scores, or to a storage device for storing the identity of the providers eligible for inclusion in a network of more cost-effective providers.

In a typical healthcare provider network the physicians and professional providers must meet credentialing criteria to be listed within the network. These criteria may include: physician/professional provider qualifications to practice in a specialty; actions of licensing boards; actions of medical staff committee on clinical privileges; quality of care issues; member complaints; malpractice cases; utilization data; Medicare/Medicaid sanctions; and information from the National Practitioner Data Bank and the Healthcare Integrity Protection Data Bank. Most healthcare insurance companies apply these criteria to determine the healthcare providers that are eligible for their network.

In addition, different healthcare insurance companies may apply additional criteria to the healthcare providers in an attempt to determine a more accurate cost-effectiveness measurement for each healthcare provider. This disclosure focuses on additional criteria applied to improve the accuracy and usefulness of the cost-effectiveness score of the healthcare providers.

The cost-effectiveness measurement can be defined as a Risk Adjusted Cost Index (“RACI”). A RACI value can be a measurement of the extent to which a physician/professional provider is more or less costly than peers within the same specialty in the same geographic region when treating patients with similar conditions. Accordingly, the RACI value is the ratio of the total allowed cost of Qualified Episodes for which a physician/professional provider is Attributed Responsibility divided by a total Expected Cost for episodes in a same Episode Group. Accordingly, the determination of a specific Expected Cost can comprise a same Severity of medical condition, a same Comorbidity Group of patient health, and the fact that the provider is working in the same Specialty and the same Geographic Region. These variables are described in greater detail herein.

An episode of care can be comprised of one or more encounters or visits, procedures or inpatient admissions. It may be built by linking sets of health care services provided to a patient over time to treat a specific disease or health status. The episode continues as long as there is relatively continuous contact with the health care system for the same basic diagnosis, disease or health status. The cost of an episode may include all allowed charges for all services provided by all physician/professional providers, ancillary providers and facilities related to that episode of care.

There may be three requirements for a Qualified Episode:

1) the episode is complete, or the specific disease or health status has been treated or is no longer at issue;

2) the episode does not have extremely low or high costs compared to similar episodes in the same Episode Group; and

3) the episode is in the normal scope of practice for the specific specialty.

The physician/professional provider may be Attributed Responsibility for an episode based upon three separate determinations, conducted in order in a hierarchy of determinations. First, the episode is attributed to the physician or professional provider who bills the greatest total Relative Value Units (“RVUs”) in that episode (excluding those billed by anesthesiologists, pathologists, and radiologists). This provider may be the primary physician.

If no physician or professional provider is identified by total RVUs, then the episode is attributed to the physician or professional provider billing the greatest number of Evaluation and Management services. This provider may be the managing physician.

If no physician or professional provider is identified by total RVUs or number of Evaluation and Management services, the episode is attributed to the physician or professional provider with the highest total allowed cost. This provider may be identified as the High Cost Clinician. In alternative embodiments, there may be different methods of determining the provider that is Attributed Responsibility. Also, in some embodiments, there may be more than one provider that is Attributed Responsibility for each episode.

As previously stated, the Expected Cost may be influenced by a Severity of the condition or illness. Severity may be classified on a scale from 0 to 4, with 4 being death, or any other number of severities can be used. Severity 1 of one disease may have different implications than Severity 1 of another disease. People with disease at Severity 2 may not be “twice” as sick as those at Severity 1. In addition, the cost of providing care for an illness at Severity 2 may not be “twice” the cost for an illness in Severity 1. Also, of course, death is an ultimate Severity level but fortunately sufficiently rare that it can often be omitted. These levels of Severity are only shown as one embodiment of this disclosure.

Severity Description

0 History of a significant predisposing factor for the disease but no current pathology, e.g. history of carcinoma or neonate born to mother suspected of infection at time of delivery

1 Conditions with no complications or problems with minimal severity

2 Problems limited to a single organ or system; significantly increased risk of complications than Severity 1

3 Multiple site involvement; generalized systemic involvement; poor prognosis

4 Death

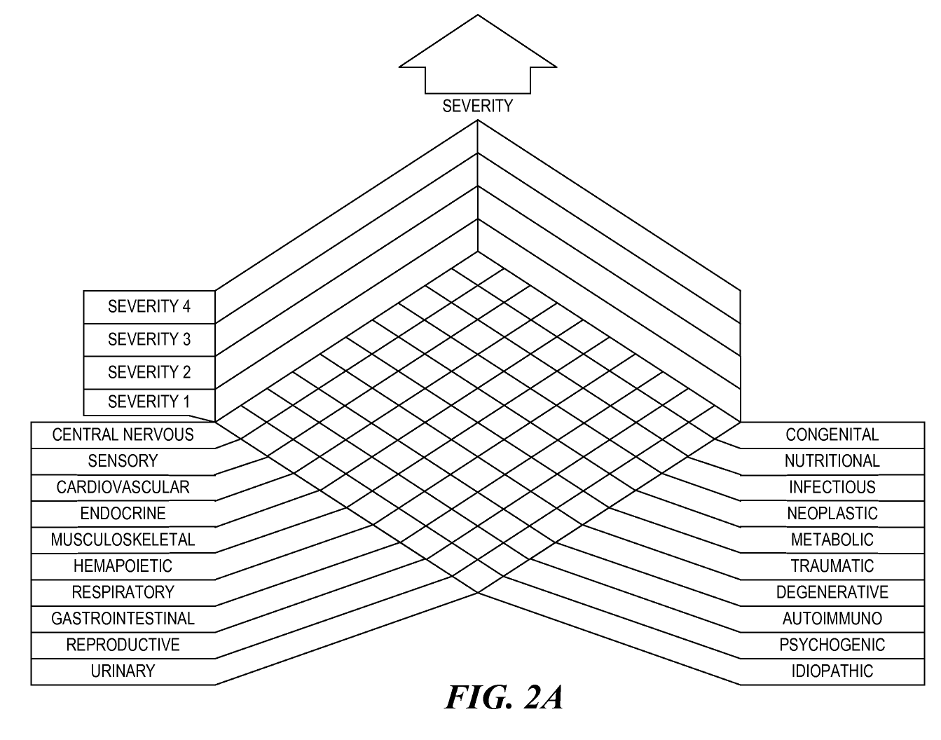

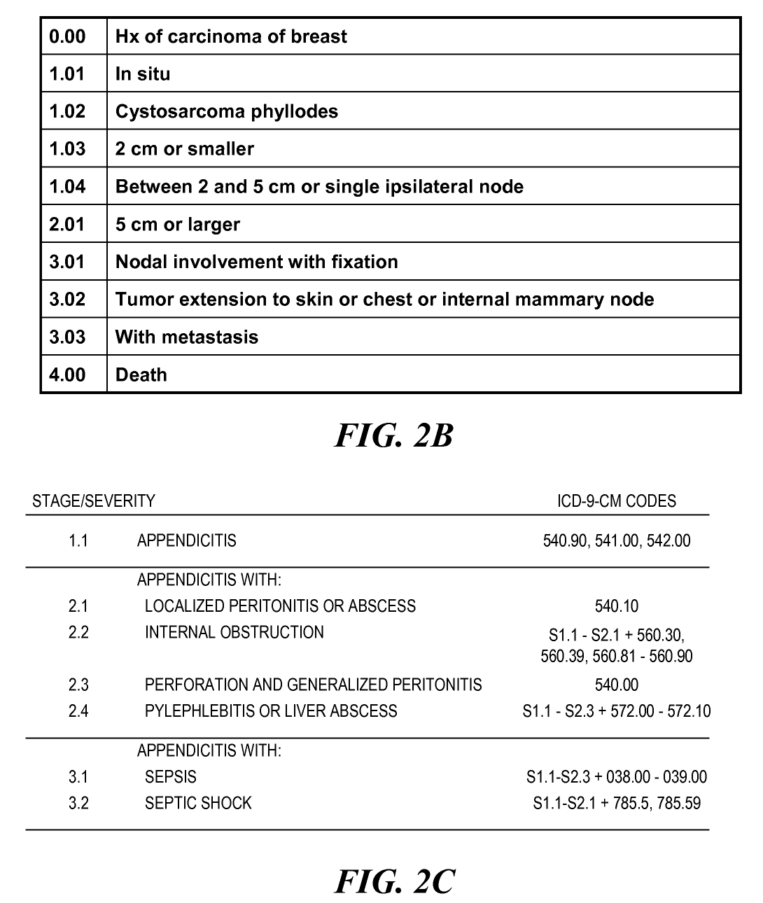

The Severity levels may be determined based upon the disease or health condition diagnosis that is coded by the healthcare provider. Condition or disease staging may involve applying three separate criteria. FIG. 2A is a diagram illustrating how the severity of an episode can be determined through three factors; severity of the disease; the organ or organs of the patient wherein the medical condition or diagnosis applies; and the etiology of the medical condition or diagnosis. One criterion may be the severity of the disease as described above. Another criterion may be the organ or organs of the patient wherein the medical condition or diagnosis applies (e.g., central nervous, sensory, endocrine, respiratory). A last criterion may be the etiology of the medical condition or diagnosis (e.g., congenital, nutritional, metabolic, degenerative). Accordingly, the type and number of organs involved and the cause or origin of the medical condition or diagnosis can be a useful factor in determining the severity of the condition.

FIG. 2B is a chart illustrating stage levels for a diagnosis of breast cancer, wherein the stages have substages and the substages are determined by symptoms or specific conditions. Although the term “stage” is commonly used to refer to a cancer health condition, the term relates to the severity of the illness. Since the term “stage” is less commonly used for health conditions other than cancer, for consistency across all health conditions, the term “severity” is generally used herein rather than “stage.” FIG. 2C is a chart illustrating severity levels for a diagnosis of appendicitis.

The Episode Group may also be influenced by a Comorbidity Group of the patient. A Relative Risk Score (“RRS”) may be used to determine the Comorbidity Group of the patient. The RRS of a patient reflects the number and complexity of diseases of that individual. The impact of Comorbidity (as indicated by RRS) on variations in cost may vary between level of severity and other factors. Little difference in cost may be observed across the range of RRS for some conditions and levels of severity. For others, the cost may rise consistently and significantly with increasing severity and RRS. The Comorbidity Groups may range from I to V (Roman numerals), or other number of Comorbidity Groups can be used. The episodes in Comorbidity Group V may not be five times more costly or complex as those in Group I.

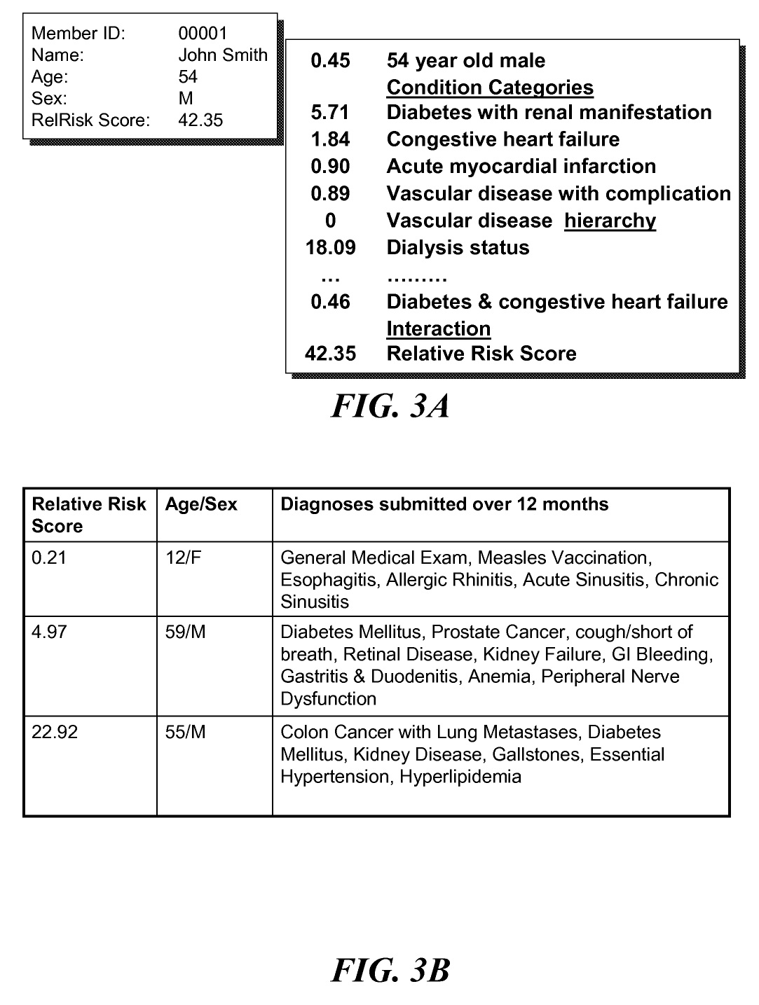

In some embodiments, the RRS may range continuously between 0 and 999. Few individuals may have an RRS over 50. FIG. 3A is a chart illustrating a RRS for a 54 year old male patient and value of each of his corresponding conditions. FIG. 3B is a chart illustrating RRSs for three different patients and their corresponding conditions. Over the entire covered population, the aggregate RRS can be normalized to 1. The methodology partitions episodes by range of RRS into five Comorbidity Groups. In one embodiment, the following steps may be used to define five Comorbidity Groups from the RRS values.

Possible combinations of RRS are statistically evaluated to find which divisions into five Comorbidity Groups best corresponded to the observed differences in cost attributable to relative risk.

Where any resulting Comorbidity Group lacks a required minimum frequency it was combined with the adjacent group.

When no statistically significant difference between the mean costs of adjacent Comorbidity Groups was present, those adjacent Comorbidity Groups were combined.

The RRS on which Comorbidity Groups are based may be created using a diagnostic classification system. The clinical profile of an individual may be created from diagnosis data using hierarchies to characterize his illness within each disease process, while accumulating the effects of unrelated disease processes. The hierarchial structures can improve the clinical validity and decrease sensitivity to overcoding in the comorbidity models. These levels of Comorbidity Groups are only shown as one exemplary embodiment of the present disclosure. Many types of risk scores and many different manners of determining a risk score are within the scope of this disclosure. In general, the divisions between Comorbidity Groups, and the divisions between the Severity factors are determined by a statistical analysis to arrive at divisions that give the Groups and Severities best relevance for determining cost-effectiveness. For example, in one embodiment, the divisions between Comorbidity Groups that each includes a range of RRS numbers are arrived at by an iterative process that tries each possible division between the ranges of RRS numbers. Then, Comobidity Group divisions are selected that have the largest statistical validity, or highest “R square” value.

As previously described, the RACI value is the ratio of the total allowed cost of Qualified Episodes for which a physician/professional provider is Attributed Responsibility divided by a total Expected Cost for episodes in a same Episode Group. Accordingly, the determination of a specific RACI Value may result from comparisons of healthcare providers treating patients in a same Episode Group, a same Severity of medical condition, and a same Comorbidity Group of patient health, and the fact that the providers are working in the same Specialty and the same Geographic Region.

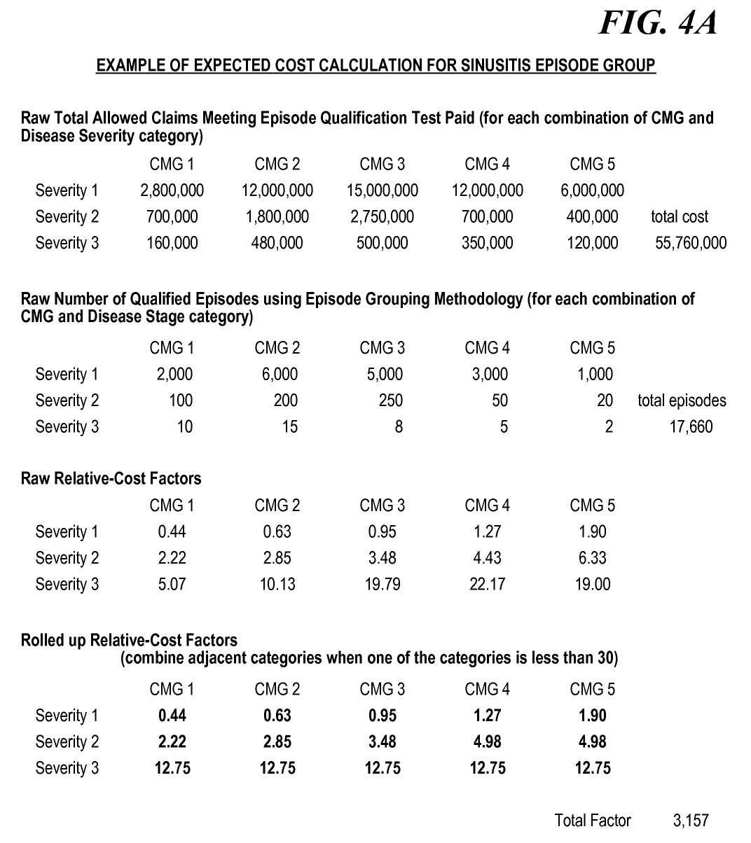

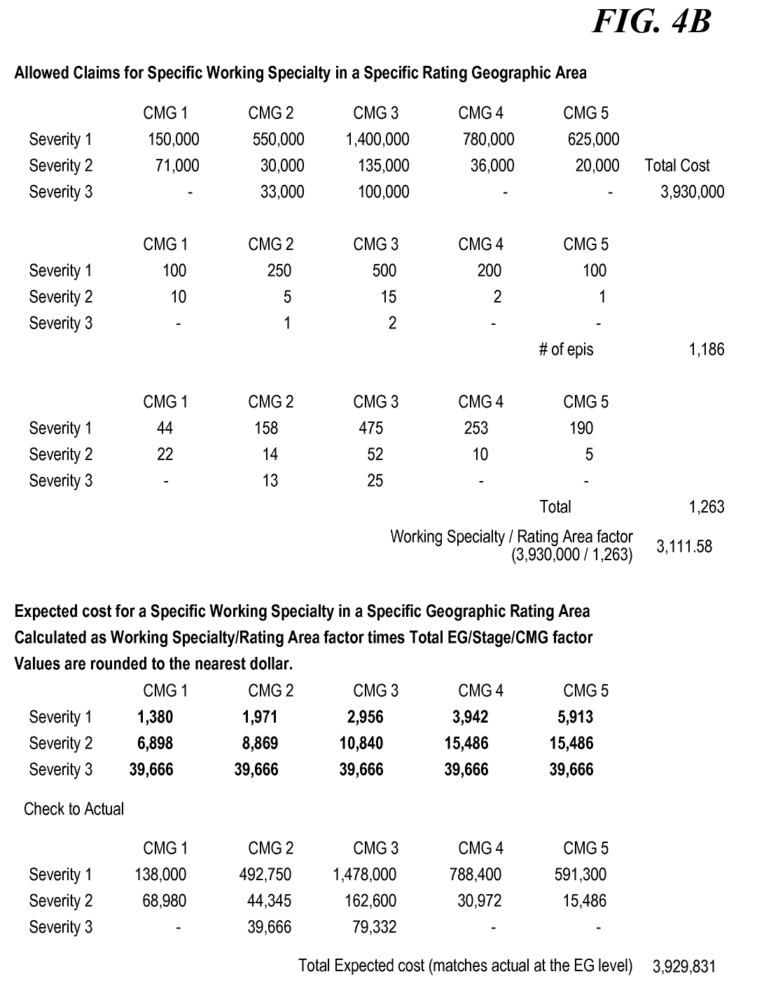

FIGS. 4A-B is a table that shows how the Expected Cost of an episode in a specific Episode Group can be determined. An Episode Group can be described as a specific disease or diagnosis. For example, this table may apply to the condition sinusitis, and therefore the episodes shown in the table relate to patients with sinusitis. This table is provided as an example of one embodiment and does not limit the present disclosure to this embodiment. The columns may be separated according to Comorbidity Groups. Accordingly, CMB1 applies to Comorbidity Group I and CMG5 applies to Comorbidity Group V. As previously described, these Comorbidity Groups may be broken down in many different manners. The rows may be separated according to a disease severity, as described above.

In this table the first set of values refers to the total cost of episodes for a specific healthcare insurance company. For patients that are classified in Severity 1 and Comorbidity I, the healthcare insurance company allowed amount was $2,800,000 for their corresponding episodes. For patients that are classified in Severity 3 and Comorbidity Group V, the healthcare insurance company allowed amount was $120,000 for their corresponding episodes. The total cost of $55,760,000 represents the total allowed amount by the healthcare insurance company for all of their customers' corresponding episodes for this specific Episode Group.

The second set of values refers to the number of episodes. As previously described, these episodes may only represent the qualified episodes. For patients that are classified in Severity 1 and Comorbidity I, the healthcare insurance company allowed amount monies for 2,000 episodes. For patients that are classified in Severity 3 and Comorbidity V, the healthcare insurance company allowed amount monies for 2 episodes. The total number of episodes was 17,660. As provided by the state factor which is determined by dividing the total cost ($55,760,000) by the total episodes (17,660), the average cost per episode is $3,157. This is an average cost.

The third set of values refer to a raw factor for the entire population of episodes with that condition in the data set, which may be an overall geographic area, such as an entire state, which applies the Severity measurement and the Comorbidity Group to the average expected cost to produce a multiplier. This multiplier can be used to determine the expected cost of an episode for a patient with a specific Severity measurement and Comorbidity Group. The raw factor for a patient that is classified in Severity 1 and Comorbidity I is 0.44. To determine this value a determination must be made of the expected cost per episode of patients under this classification. Accordingly, the total cost ($2,800,000) is divided by the number of episodes (2,000) for Severity 1 and Comorbidity I, and the result is $1,400 per episode. This result is then divided by the raw factor of average cost per episode ($3,157) to get the state factor of 0.44. In similar fashion for Severity 3 and Comorbidity V, the total cost ($120,000) is divided by the number of episodes (2), and the result is $60,000 per episode. This result divided by the raw factor produces the raw factor of 19.00.

The fourth set of values refers to a rolled up relativity factor, which is similar to the raw factor. For the rolled up relativity factor, patients that are classified in specific groups are combined with patients classified in other groups so that a large enough number of episodes is applied. This step may be taken to ensure that there is a large enough sample group to provide an accurate relative factor. For example, there were only 2 episodes for patients classified by Severity 3 and Comorbidity V. Therefore, all of the patients classified by Severity 3 have been grouped together to provide a sample group of 40. In one embodiment, a sample group cannot be less than 30 episodes. In one embodiment, the adjacent episodes are rolled-up or combined beginning with the episode associated with the larger Comorbidity Group and combining it with the adjacent lower Comorbidity Group until no bin has less than 30 episodes. A sample group of 40 may provide a more accurate relativity factor than a sample group of 2. Accordingly, the total cost in Severity 3 (160,000+480,000+500,000+350,000+120,000=$1,610,000) is divided by the total number of episodes (40), and the result is $40,250. This result divided by the state factor produces the relativity factor of 12.75. This procedure was also followed for the patients classified in Severity 2 and Comorbidity IV and V.

In FIG. 4B, the fifth set of values refers to the total costs of episodes for a specific Working Specialty and/or a specific Geographical Area. The classification of Working Specialty refers to the area of practice of the healthcare provider (e.g., oncologist, urologist). The classification of Geographical Area refers to the geographical location of the healthcare provider (e.g., large city, rural city). In one embodiment, a three-digit ZIP code Geographic Area can be used. Accordingly, healthcare providers may be compared with other providers that practice in the same area of medicine because different areas of medicine can entail significantly different costs per episode. Healthcare providers may be compared with other providers that practice in the same geographical location because practicing medicine in some locations can be more costly than practicing medicine in other locations. For this example, the exact Working Specialty and Geographical Area is not provided.

This fifth set of values refers to the total cost of episodes for within a specific Working Specialty and/or Geographical location. For patients that are classified in Severity 1 and Comorbidity I, the healthcare insurance company allowed amount was $150,000 for their corresponding episodes. For patients that are classified in Severity 2 and Comorbidity Group V, the healthcare insurance company allowed amount was $20,000 for their corresponding episodes. The total cost of $3,930,000 represents the total allowed amount by the healthcare insurance company for all of their customers' corresponding episodes. As shown, there were no episodes recorded for Severity 3 and Comorbidity Groups I, IV, and V.

The sixth set of values refers to the number of episodes within this specific Working Specialty and/or Geographic Location. As previously described, these episodes may only represent the qualified episodes. For patients that are classified in Severity 1 and Comorbidity I, the healthcare insurance company allowed amount monies for 100 episodes. For patients that are classified in Severity 3 and Comorbidity V, the healthcare insurance company allowed amount monies for 1 episode. The total number of episodes was 1,186.

The seventh set of values refers to the number of episodes applied to the relativity factor discussed with reference to the fourth set of values. Accordingly, in Severity 1 and Comorbidity Group I the relativity factor was 0.44 and the number of episodes was 100. The number of episodes (100) is multiplied by the relativity factor (0.44) to get a value of 44. After the adjustment of the number of episodes with the relativity factor, the total unit value is 1,263. The difference between this total unit value and the actual number of episodes is due to the application of the relativity factor. The relativity factor is applied to provide an accurate expected cost per episode, since the sample group is smaller when these numbers are classified by Working Specialty and Geographic Location. In other embodiments, either Working Specialty or Geographic location can be used, or both can be used with unequal weighting.

The cost per unit in this Working Specialty and/or Geographic Location is determined by dividing the total cost ($3,930,000) by the total units (1,263), and the result is $3,111.58. This is an average unit cost without application of Severity and/or Comorbidity Group. This average cost per unit is smaller than the total average cost per episode described above. Accordingly, healthcare insurance companies could expect healthcare providers in this Working Specialty and/or Geographic Location to adhere to a lower cost per episode than other Specialties and/or Geographic Locations.

The eighth set of values further applies the Severity measurement and Comorbidity Group of the patients to the average cost per episode within this specific Working Specialty and/or Geographic Location. For patients that are classified in Severity 1 and Comorbidity I, the expected average cost per episode is $1,380 ($3111.58* *0.44). For patients that are classified in Severity 2 and Comorbidity Group V, the average cost per episode is $15,486 ($3111.58*4.98). This value may be the Expected Cost per episode for a healthcare provider as described above. This Expected Cost per episode is dependent upon a Severity measurement of the condition, a Comorbidity Group of the patient, and the Working Specialty and/or the Geographical Location of the healthcare provider. This Expected Cost per episode enables a healthcare insurance company to accurately measure costs between providers in the same peer group who are providing care for the same types of patients.

As previously described, the RACI measurement may be applied to a provider using this Expected Cost per episode. For example, a provider, within the same Working Specialty and/or Geographical Location as provided above, cares for 10 separate episodes for patients classified in Severity 2 and Comorbidity Group 2. The allowed cost for these 10 episodes was $90,000. Therefore, the provider's average cost per episode is $9,000. From the table, the expected average cost per episode is $8,869. This indicates that the provider is costing the healthcare insurance company a larger amount than the expected average cost per episode. In one embodiment, the RACI value would be 1.015 (actual average cost $9,000/expected average cost $8,869). A RACI value above 1.00 indicates that the provider is operating above the expected cost per episode.

As another example, a provider, within the same Working Specialty and/or Geographical Location as provided above, cares for 15 separate episodes for patients classified in Severity 1 and Comorbidity Group 4. The allowed cost for these 15 episodes was $45,000. Therefore, the provider's average cost per episode is $3,000. From the table, the expected average cost per episode is $3,942. This indicates that the provider is costing the healthcare insurance company a smaller amount than the expected average cost per episode. In one embodiment, the RACI value would be 0.761 (actual average cost $3,000/expected average cost $3,942). A RACI value below 1.00 indicates that the provider is operating below the expected cost per episode. This method of determining a RACI value provides one embodiment of the present disclosure, and therefore this disclosure is not limited to this specific embodiment.

In addition, a healthcare provider's RACI value can be determined for the total amount of episodes that have been attributed to him or her. For example, a provider has received 5 different RACI values from 5 different classifications of patients.

| # of | Avg Cost | Expected Cost | Avg Cost * | Exp Cost * |
|---|---|---|---|---|
| Episodes | Per episode | Per episode | # of Epi | # of Epi |
| 13 | 500 | 600 | 6,500 | 7,800 |
| 11 | 700 | 850 | 7,700 | 9,350 |
| 17 | 1,200 | 1,100 | 20,400 | 18,700 |
| 9 | 1,800 | 1,750 | 16,200 | 15,750 |
| 14 | 2,500 | 2,200 | 35,000 | 30,800 |
| | | | 85,800 | 82,400 |
| | | | RACI | 1.04 |

By weighting the average cost by the number of episodes (13*500=6,500; 11*700=7,700; 17*1,200=20,400; 9*1,800=16,200; 14*2,500=35,000) an aggregate total allowed cost can be determined (85,800). By weighting the expected cost by the number of episodes (13*600=7,800; 11*850=9,350; 17*1,100=18,700; 9*1,750=15,750; 14*2,200=30,800) an aggregate total expected cost can be determined (82,400). This total allowed cost (85,800) is divided by the total expected cost (82,400) to determine a RACI value (1.04). Therefore, the 1.04 may be used as a RACI value for the provider. This RACI value may be more accurate than prior efforts to evaluate the cost effectiveness of a provider because it has factored in all of the qualified episodes that this provider has been attributed.

Accordingly, the healthcare insurance company may determine a provider's cost-effectiveness based upon these RACI values. A healthcare provider with a lower RACI value could be determined to be a more cost-effective healthcare provider than a healthcare provider with a higher RACI value. This RACI value may be utilized by the health care insurance companies to create their provider network of more cost-effective providers. It is advantageous for healthcare insurance companies to create their provider networks with the most cost-effective providers.

From this methodology, a healthcare provider is compared to his peers that provide care in the same Working Specialty and the same geographical location. In addition, a healthcare provider is also compared to other providers that are caring for the same types of patients with the same conditions. Healthcare providers that care for patients that have severe conditions (high levels Severity) are compared with other providers that care for patients with similar conditions. Healthcare providers that care for patients that have multiple additional diseases or medical conditions (high Comorbidity Group) are compared with other providers that care for patients with similar medical backgrounds. Therefore, providers who care for very ill patients with a severe condition and/or multiple co-morbid conditions are not penalized. These factors clearly improve the accuracy of the risk adjusted cost index (RACI) measurement for healthcare providers.

To be listed on the provider network of a healthcare insurance company for more cost-effective providers, the provider may need to have a RACI value under a threshold and a minimum number of completed episodes. Meeting the threshold RACI and having the minimum number of completed episodes may not guarantee participation in the provider network. When providers have exceptionally high utilization, detailed claims review may be performed by experienced personnel. In addition, adherence to evidence-based medicine may be required to be listed on the provider network. A healthcare insurance company may use evidence-based indicators to assess important aspects of clinical care based on claims and enrollment data. Overall performance across indicators may be used as additional screening criteria in determining eligibility.

In further embodiments, specific data which is applied to the Expected Cost calculation may be flagged and trimmed according to certain criteria to ensure accurate data. This general framework for methodology is only provided as an example and does not limit this disclosure to these methodologies. The healthcare insurance companies may follow these steps to provide more accurate and precise data while determining the Expected Cost:

Flag incomplete episodes.

2. Flag episodes with insufficient membership. Flag any episode with MMY (members months for the year of the last date of service of the episode) equal to 0. Flag chronic maintenance, chronic non-stratified), and well care episodes with fewer than 9 MMY. Flag acute and chronic acute flare-up episodes with fewer than 2 MMY.

3. Flag episodes where no relative risk score was calculated for the member.

4. Flag episodes that are overall low outliers. Flag episodes that have a total allowed amount less than $30.

5. Flag episodes with a responsible provider in the Exclusion list.

6. Flag episodes where the responsible provider is not a clinician. Flag episodes where none of the Primary, Managing, or High Cost Clinician fields were able to be assigned a clinician—the fields are blank. The list of clinicians is the same as the list that is used for the assignment of the High Cost Clinician field.

7. Flag episodes that are outside the normal scope of practice for a Working Specialty according to our data set. Excluding all of the flagged episodes from the above 6 steps, flag episodes that are included in classifications (factors of severity, comorbidity, Working Specialty, and/or geographical location) with fewer than 10 remaining episodes.

8. Apply high trim. Calculate averages for the different classifications excluding any episodes that have been flagged in the first 7 steps. Within a given classification, flag episodes that are greater than 15 times the average for that classification.

9. Apply low trim. Recalculate the averages for the different classifications excluding the flagged episodes from the first 8 steps. Within a given classification, flag episodes that are less than 1/15 times the recalculated average for that classification.

10. Apply minimum quantity trim. If the classification contains fewer than 30 un-flagged episodes, then flag the entire classification.

11. Establish the bin partition values. The bin partition values can be defined as the cost values and the number of episodes for a specific classification. Each bin partition refers to a specific classification (factors of severity, comorbidity, and health condition).

12. Determine relativity factors for each bin. This process was described with reference to the table of FIGS. 4A-B.

13. Determine the Expected Cost per episode for a specific classification. This process was described with reference to the table of FIGS. 4A-B.

In one embodiment of this disclosure, the Step 10 of “applying minimum quantity trim” may involve the following procedures. For example, a computer system may check for classifications with less than 30 qualified episodes, and combine classification groups with less than 30 episodes with adjacent classification groups. Then, the system may continue this process until all of the classification groups have at least 30 episodes. The new classification groups are then used, wherein no classification groups have fewer than 30 episodes. This process enables each classification to have at least a specific amount (30) of qualified episodes.

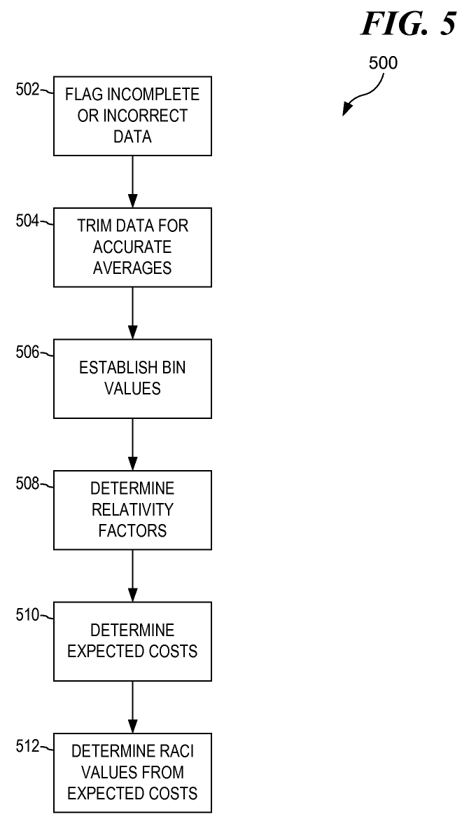

FIG. 5 is a flow chart 500 that represents the process of determining a RACI value for a healthcare provider. First, incomplete or incorrect data is flagged 502, so that this data is not utilized to determine the Expected Cost per episode. Then, the data is further trimmed 504 to remove anomalies or inconsistent data. The bin values may then be established 506 for costs and numbers of episodes. The relativity factors may be produced from the bin values 508, as previously described. The system then determines the Expected Costs 510 from the relativity factors, wherein the Expected Costs are dependent upon multiple factors for each type of healthcare condition (Severity, Comorbidity Groups, Working Specialty, and Geographic Location). Lastly, the RACI values for healthcare providers can be determined from the Expected Costs 512. The RACI values can be used by the healthcare insurance company to determine a healthcare provider's cost cost-effectiveness.

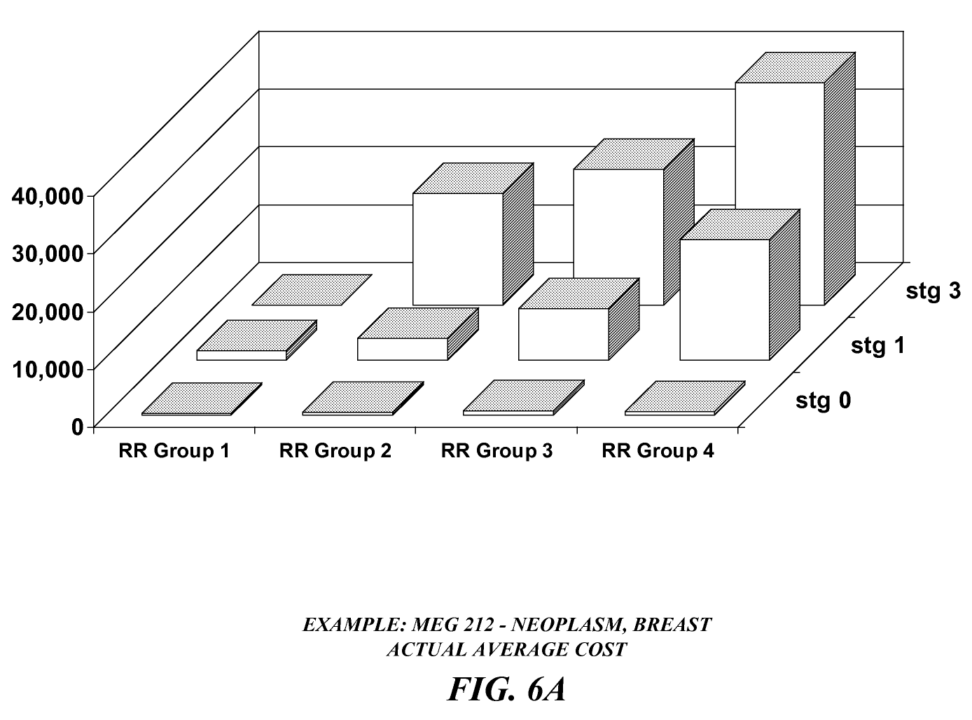

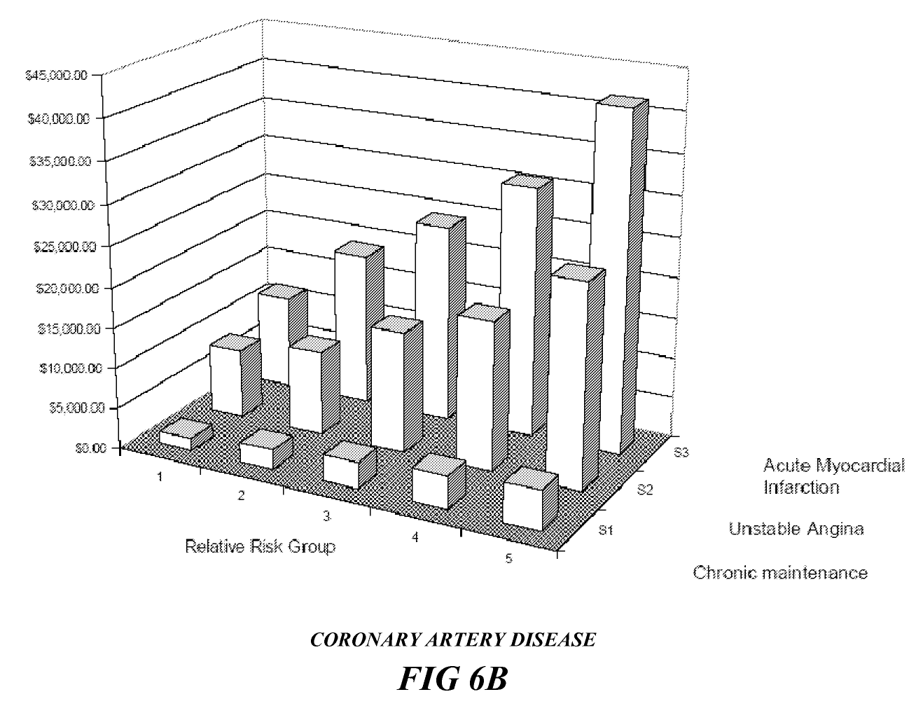

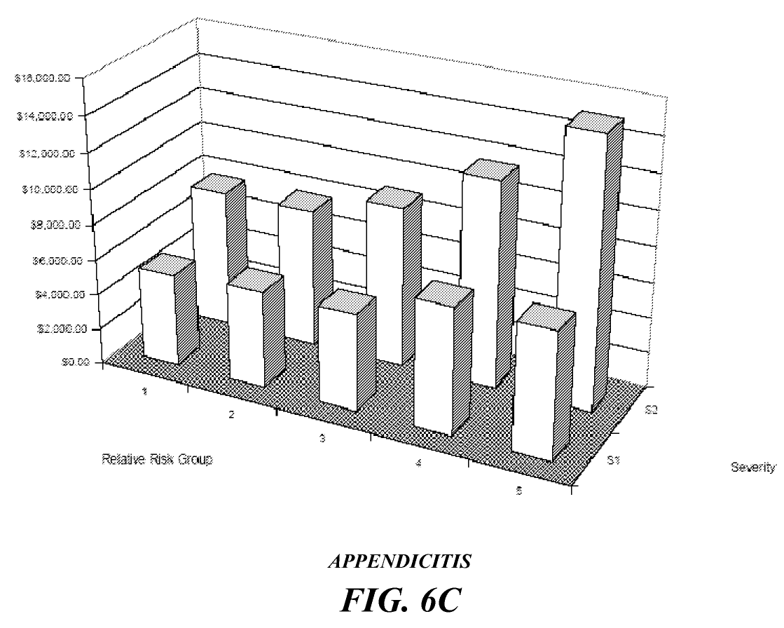

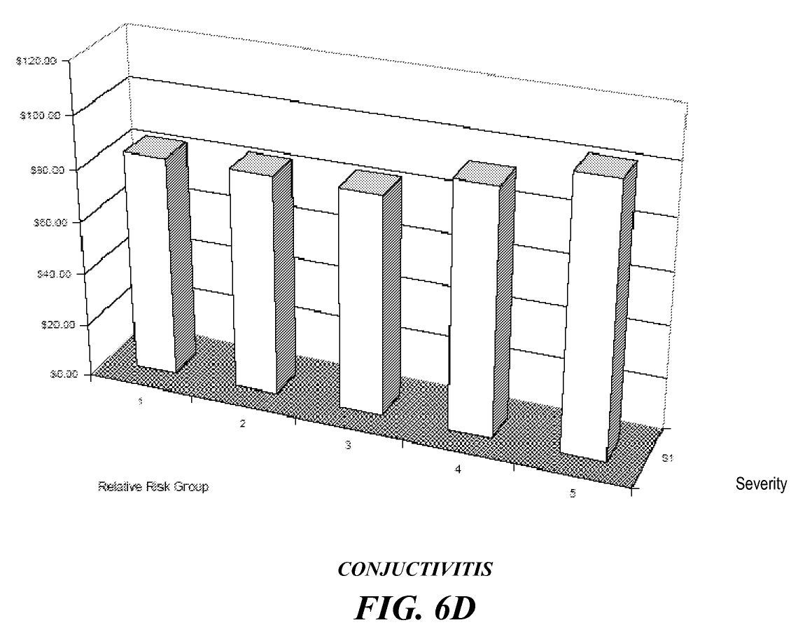

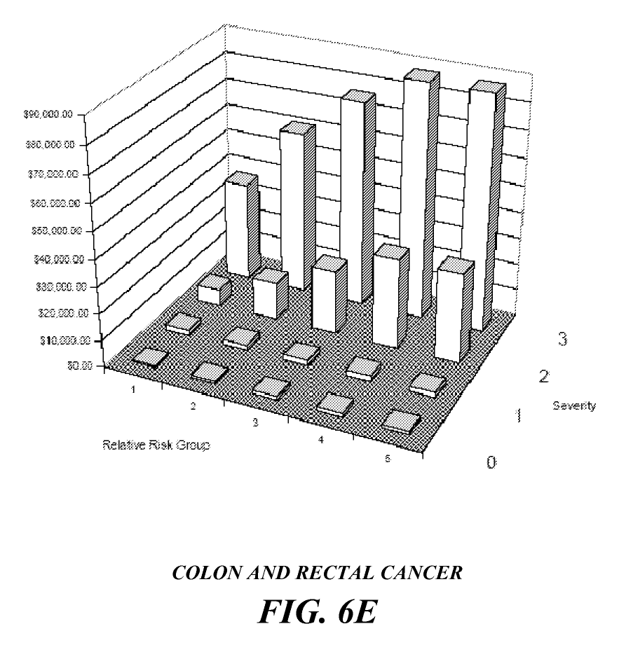

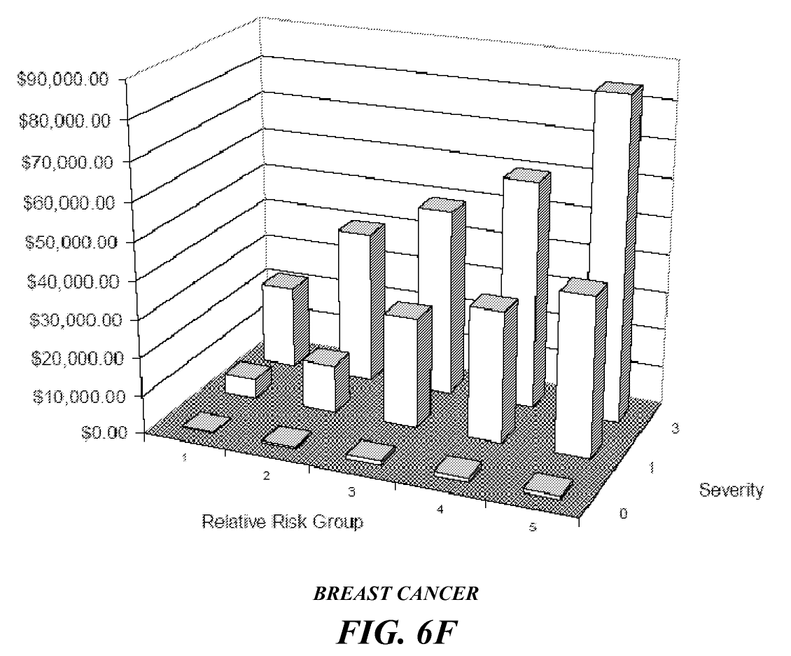

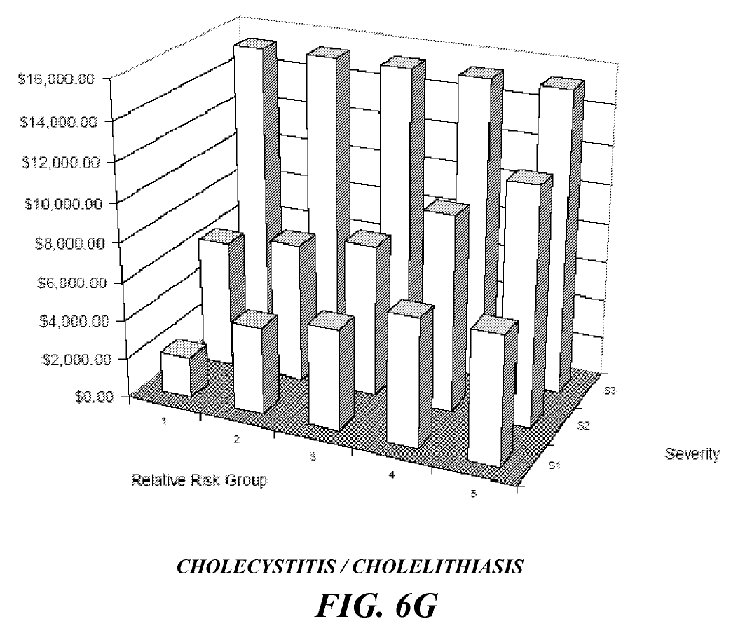

FIG. 6A is a bar graph illustrating the actual average cost for patients with breast neoplasm, wherein the patients have varying relative risk and varying severities of the condition.

FIG. 6B is a bar graph illustrating the actual average cost for patients with coronary artery disease, wherein the patients have varying relative risk and varying severities of the condition.

FIG. 6C is a bar graph illustrating the actual average cost for patients with appendicitis, wherein the patients have varying relative risk and varying severities of the condition.

FIG. 6D is a bar graph illustrating the actual average cost for patients with conjuctivitis, wherein the patients have varying relative risk and varying severities of the condition.

FIG. 6E is a bar graph illustrating the actual average cost for patients with colon cancer and/or rectal cancer, wherein the patients have varying relative risk and varying severities of the condition.

FIG. 6F is a bar graph illustrating the actual average cost for patients with breast cancer, wherein the patients have varying relative risk and varying severities of the condition.

FIG. 6G is a bar graph illustrating the actual average cost for patients with a cholecystitis and/or cholelithiasis, wherein the patients have varying relative risk and varying severities of the condition.

As shown in FIGS. 6A-G, the average cost per episode varies greatly from one medical condition to the next. Accordingly, Severity 1 of one condition can be very different from Severity 1 of another condition. For this reason, the claimed invention separates the Expected Cost per episode tables by Episode Groups.

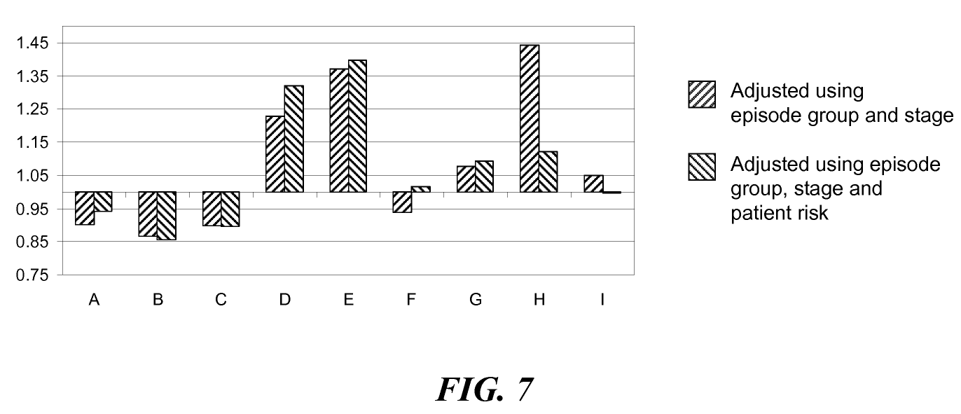

FIG. 7 is a bar graph illustrating the difference in RACI values for specific healthcare providers, wherein one RACI value is adjusted using episode group and severity and another RACI value is adjusted using episode group, severity and relative risk. Accordingly, each healthcare provider (A-I) has a different RACI value, wherein a RACI value of 1.0 indicates that the healthcare provider is operating exactly at Expected Cost per episode. This bar graph illustrates that utilizing a patient risk value may change each provider's RACI value, and that this risk value is an important factor to consider.

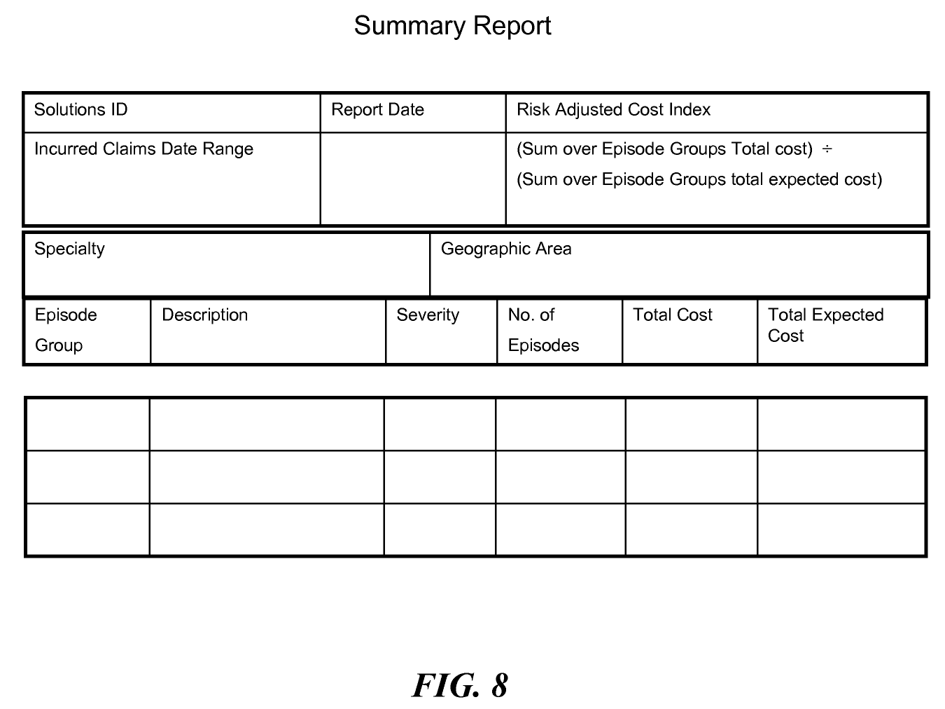

FIG. 8 is a sample summary report that may be supplied to a healthcare provider, wherein the summary report may help the provider determine how his RACI value was determined. Accordingly, the provider may see his Risk Adjusted Cost Index (“RACI”) value, and the number, types, and costs of episodes that led to this RACI value.

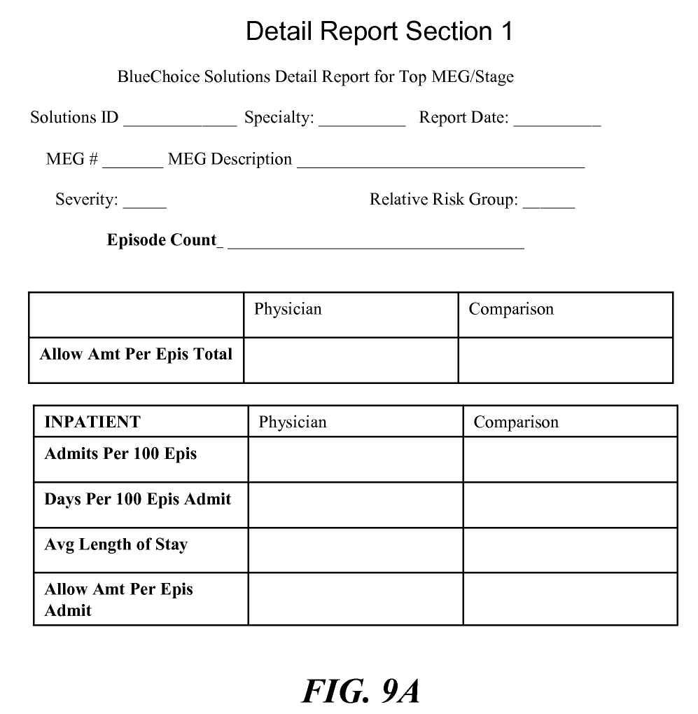

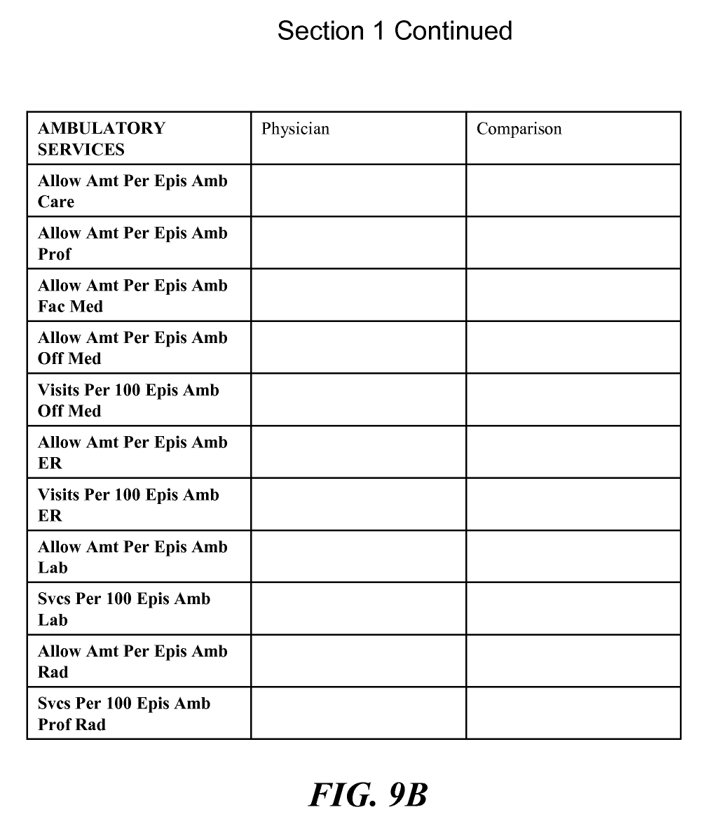

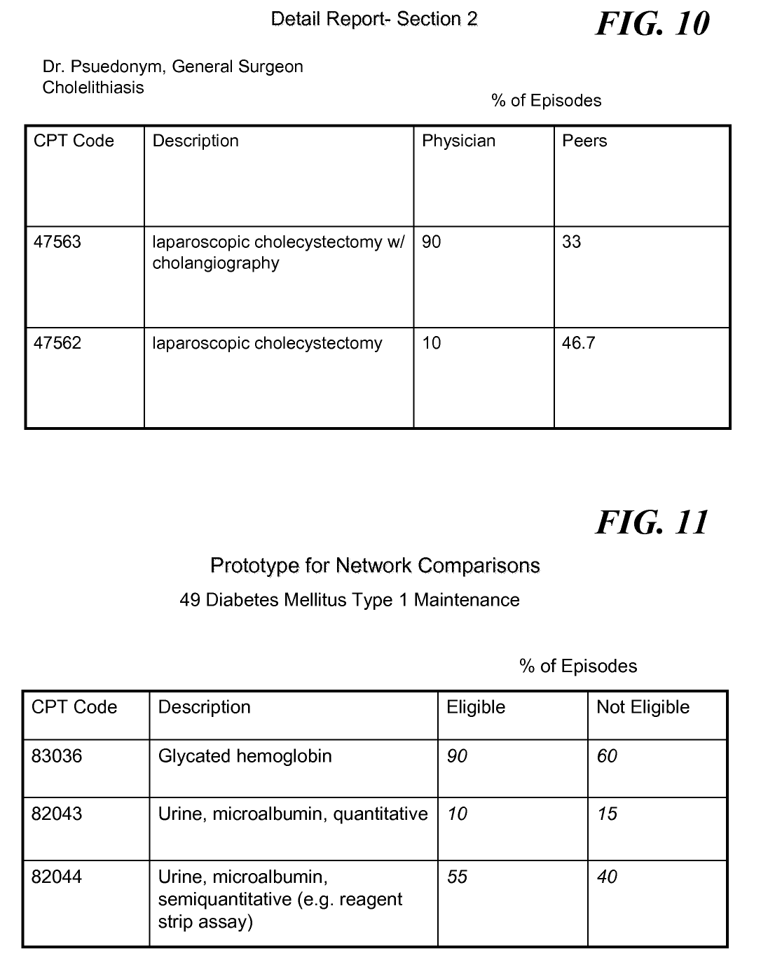

FIGS. 9A-B is a sample detail report that may be used to compare the cost and type of treatment applied to patients within a specific episode group. This type of report may help a provider to determine if he is following similar procedures to his peers. FIG. 10 is a sample detail report that illustrates the different procedures carried out by a specific healthcare provider for a patient with cholelithiasis and how this provider compares to his peers. Therefore, for each episode or condition the healthcare provider can compare the procedures performed to his peers for the same conditions. For example, for cholelithiasis Dr. Pseudonym performs procedure code 47563 90% of the time, whereas his peers only perform this procedure 33% of the time. These types of detailed reports enable a healthcare provider to compare his procedures with those of his peers.

FIG. 11 is a sample detail report that illustrates the different procedures carried out by eligible (for a network of more cost-effective providers) and not eligible healthcare providers for patients with Diabetes Mellitus and the comparison between these providers. This table further breaks down the procedures performed by eligible and not eligible providers. Eligible providers are healthcare providers that are listed on the healthcare insurance company's network of more cost-effective providers. This table enables a provider to view the procedures followed by providers in the network and providers not in the network, which may give the provider an ability to compare to the procedures used by the more cost effective peers. For example, for Diabetes Mellitus 90% of eligible providers perform procedure code 83036, whereas only 60% of not eligible providers perform this procedure. Therefore, procedure 83036 appears to be an accepted procedure within the provider network.

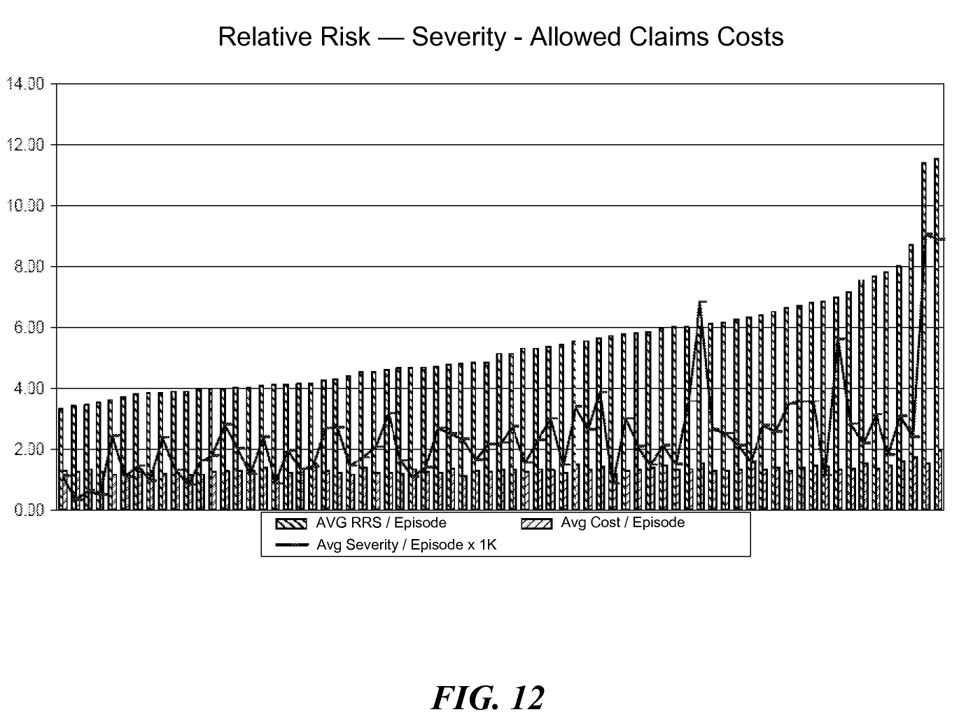

FIG. 12 is a bar graph illustrating the average relative risk/episode, the average severity/episode, and the average allowed cost/episode. This graph shows that there is a correlation between the relative risk, severity, and allowed cost per episode. Accordingly, as the relative risk and severity go higher, the average allowed cost steadily climbs higher also. This graph also shows that the average cost per episode is unpredictable and can vary greatly, even between adjacent classification groups.

It is important to note that although the present invention determines a cost-effectiveness for a provider, use of a more cost-effective provider does not result in a lower quality of care for the patient. In fact, because the system and method measures the cost of a completed episode of a healthcare condition, and takes into account both the severity of the healthcare condition and the comorbidity factors relating to the patient, the quality of care that patients receive from the more cost-effective provider can be the same as for other less cost-effective providers, but at a lower cost. For example, one provider may choose more expensive tests or treatments for a patient early on in the course of a health condition episode than other providers.

1. A method of creating a cost index measurement for a service provider, the method comprising:
receiving input data relating to multiple service providers, the input data comprising diagnosis data, service cost data and number of episodes;
arranging the input data into a first plurality of groups;
determining a relative cost factor for each of at least two groups of the first plurality;
selecting a subset from each of the at least two groups, the subsets having common selection criteria;
determining an expected cost for each of the subsets using a corresponding one of the relative cost factors; and
determining the cost index measurement for the service provider using the expected costs and service provider cost data.

2. The method of claim 1 wherein the service provider comprises a healthcare provider, wherein the diagnosis data comprises health condition diagnosis data, and wherein the service cost data comprises treatment cost data.

3. The method of claim 1 wherein arranging the input data into a first plurality of groups comprises:
grouping the data by at least two criteria selected from the list consisting of:
condition severity, etiology, comorbidity, service provider specialty and geographic region.

4. The method of claim 1 wherein determining a relative cost factor comprises:
calculating a first average service cost, the first average service cost comprising an average service cost for at least two groups of the first plurality;
calculating a second average service cost, the second average service cost comprising an average service cost for a single group; and
dividing the second average by the first average.

5. The method of claim 1 wherein the selection criteria comprises at least two criteria selected from the list consisting of:
condition severity, etiology, comorbidity, service provider specialty and geographic region.

6. The method of claim 1 wherein determining an expected cost for each of the subsets comprises:
multiplying the number of episodes in each subset by the corresponding one of the relative cost factors to determine an adjusted number of episodes in each subset;
summing the adjusted number of episodes;
calculating an adjusted average cost using the sum of the adjusted number of episodes; and
multiplying the adjusted average cost with the corresponding one of the relative cost factors.

7. The method of claim 1 wherein determining the cost index measurement for the service provider comprises:
for at least one of the subsets, comparing the expected costs for the subset with service provider cost data corresponding to the subset.

8. The method of claim 7 wherein comparing comprises:
calculating a ratio.

9. The method of claim 1 wherein determining the cost index measurement for the service provider comprises:
comparing a weighted sum of the expected costs for at least two subsets with a weighted sum of service provider cost data corresponding to the subsets, wherein the weighting is the number of episodes for each subset.

10. The method of claim 9 wherein comparing comprises:
calculating a ratio.

11. The method of claim 1 further comprising:
adjusting the relative cost factor for a group if the number of episodes in the group is below a threshold.

12. The method of claim 11 wherein adjusting the relative cost factor comprises:
determining an alternate relative cost factor by combining multiple groups such that the number of episodes in the combined groups meets the threshold.

13. A computer program, embodied on a computer readable medium and executable by a processor, the program comprising:
code for receiving input data relating to multiple service providers, the input data comprising diagnosis data, service cost data and number of episodes;
code for arranging the input data into a first plurality of groups;
code for determining a relative cost factor for each of at least two groups of the first plurality;
code for selecting a subset from each of the at least two groups, the subsets having common selection criteria;
code for determining an expected cost for each of the subsets using a corresponding one of the relative cost factors; and
code for determining the cost index measurement for the service provider using the expected costs and service provider cost data.

14. The program of claim 13 wherein the service provider comprises a healthcare provider, wherein the diagnosis data comprises health condition diagnosis data, and wherein the service cost data comprises treatment cost data.

15. The program of claim 13 wherein the code for arranging the input data into a first plurality of groups comprises:
code for grouping the data by at least two criteria selected from the list consisting of:
condition severity, etiology, comorbidity, service provider specialty and geographic region.

16. The program of claim 13 wherein the code for determining a relative cost factor comprises:
code for calculating a first average service cost, the first average service cost comprising an average service cost for at least two groups of the first plurality;
code for calculating a second average service cost, the second average service cost comprising an average service cost for a single group; and
code for dividing the second average by the first average.

17. The program of claim 13 wherein the selection criteria comprises at least two criteria selected from the list consisting of:
condition severity, etiology, comorbidity, service provider specialty and geographic region.

18. The program of claim 13 wherein the code for determining an expected cost for each of the subsets comprises:
code for multiplying the number of episodes in each subset by the corresponding one of the relative cost factors to determine an adjusted number of episodes in each subset;
code for summing the adjusted number of episodes;
code for calculating an adjusted average cost using the sum of the adjusted number of episodes; and
code for multiplying the adjusted average cost with the corresponding one of the relative cost factors.

19. The program of claim 13 wherein the code for determining the cost index measurement for the service provider comprises:
code for comparing the expected costs for at least one of the subsets with service provider cost data corresponding to the subset.

20. The method of claim 19 wherein comparing comprises:
calculating a ratio.

21. The program of claim 13 wherein the code for determining the cost index measurement for the service provider comprises:
code for comparing a weighted sum of the expected costs for at least two subsets with a weighted sum of service provider cost data corresponding to the subsets, wherein the weighting is the number of episodes for each subset.

22. The method of claim 21 wherein comparing comprises:
calculating a ratio.

23. The program of claim 13 further comprising:
code for adjusting the relative cost factor for a group if the number of episodes in the group is below a threshold.

24. The method of claim 11 wherein the code for adjusting the relative cost factor comprises:
code for determining an alternate relative cost factor by combining multiple groups such that the number of episodes in the combined groups meets the threshold.

25. A system for creating a cost index measurement for a service provider, the system comprising:
means for receiving input data relating to multiple service providers, the input data comprising diagnosis data, service cost data and number of episodes;
means for arranging the input data into a first plurality of groups;
means for determining a relative cost factor for each of at least two groups of the first plurality;
means for selecting a subset from each of the at least two groups, the subsets having common selection criteria;
means for determining an expected cost for each of the subsets using a corresponding one of the relative cost factors; and
means for determining the cost index measurement for the service provider using the expected costs and service provider cost data.

26. The system of claim 25 wherein the service provider comprises a healthcare provider, wherein the diagnosis data comprises health condition diagnosis data, and wherein the service cost data comprises treatment cost data.

27. The system of claim 25 wherein the means for arranging the input data into a first plurality of groups comprises:
means for grouping the data by at least two criteria selected from the list consisting of:
condition severity, etiology, comorbidity, service provider specialty and geographic region.

28. The system of claim 25 wherein the means for determining a relative cost factor comprises:
means for calculating a first average service cost, the first average service cost comprising an average service cost for at least two groups of the first plurality;
means for calculating a second average service cost, the second average service cost comprising an average service cost for a single group; and
means for dividing the second average by the first average.

29. The system of claim 25 wherein the selection criteria comprises at least two criteria selected from the list consisting of:
condition severity, etiology, comorbidity, service provider specialty and geographic region.

30. The system of claim 25 wherein the means for determining an expected cost for each of the subsets comprises:
means for multiplying the number of episodes in each subset by the corresponding one of the relative cost factors to determine an adjusted number of episodes in each subset;
means for summing the adjusted number of episodes;
means for calculating an adjusted average cost using the sum of the adjusted number of episodes; and
means for multiplying the adjusted average cost with the corresponding one of the relative cost factors.

31. The system of claim 25 wherein the means for determining the cost index measurement for the service provider comprises:
means for comparing the expected costs for at least one of the subsets with service provider cost data corresponding to the subset.

32. The system of claim 25 wherein the means for determining the cost index measurement for the service provider comprises:
means for comparing a weighted sum of the expected costs for at least two subsets with a weighted sum of service provider cost data corresponding to the subsets, wherein the weighting is the number of episodes for each subset.

33. The system of claim 25 further comprising:
means for adjusting the relative cost factor for a group if the number of episodes in the group is below a threshold.

34. The method of claim 11 wherein the means for adjusting the relative cost factor comprises:
means for determining an alternate relative cost factor by combining multiple groups such that the number of episodes in the combined groups meets the threshold.

35. A method of evaluating the relative cost of a healthcare provider as compared to a other healthcare providers in providing healthcare services to treat a plurality of diagnosed health conditions of varying severities in patients having different health-cost risks, comprising the steps of:
for each health condition of said plurality of diagnosed health condition:
inputting data taken from an overall population of providers in an overall geographic area relating to the cost of treating said diagnosed health condition in each of a plurality of patients in a health-cost risk group and having a severity category for said diagnosed health condition, each of said diagnosed health conditions having initiated an episode of care for treating said diagnosed health condition in each of said patients;
trimming said data that do not meet one or more of a set of data quality criteria to arrive at a trimmed data set of qualified episodes of care;
assigning episode of care data for each patient to one of a plurality of health-cost risk groups based upon similarity of the cost of the treatment of the patient to other patients having an episode of care for same diagnosed health condition of the same category of severity;
calculating the total cost of treatment of said diagnosed health condition for all qualified episodes of care for each severity category of said diagnosed health condition in each of said health-cost risk groups;
calculating the total number of qualified episodes of care for said diagnosed health condition for each severity category of said diagnosed health condition in each of said health-cost risk groups;
where the number of qualified episodes of care for a particular combination of health-cost risk group and severity category is less than a predetermined value, combining costs for a sufficient number of adjacent health-cost risk groups together such that said number of qualified episodes of care for a particular severity category is greater than or equal to said predetermined value;
using uncombined costs, or combined costs where such costs have been combined, calculating an average cost per qualified episode of care for each severity category of said diagnosed health condition in each of said health-cost risk groups;
for each health-cost risk group,
totaling the average costs per episode of care for each of the severity categories and
calculating the relative fraction of the total health-cost risk group is represented by each severity category to determine a relative-cost factor;
determining an expected average cost per episode for a subset of said population of providers corresponding to providers of a particular working specialty and in a particular subset of said overall geographic area by:
inputting data for said subset of providers, said data corresponding to the cost of treating a qualified episode of care for patients of that subset of said population of providers, and segregating both number of qualified episodes of care and the total costs of qualified episodes of care into separate categories for each severity category of said diagnosed health condition in each of said health-cost risk groups;
calculating an average cost per qualified episode of care for each severity category of said diagnosed health condition in each of said health-cost risk groups;
multiplying the relative-cost factor for each corresponding severity category of said diagnosed health condition in each of said health-cost risk groups to calculate an expected cost per qualified episode of care for each of said health conditions in each of said severity categories and health-cost risk groups;
for a particular provider in the subset of said overall population of providers, determining a cost-effectiveness ratio for that provider by:
for each health condition diagnosed by that provider, inputting data for said provider corresponding to that provider's cost of treating qualified episodes of care for that provider's patients, segregating both number of qualified episodes of care and the total costs of qualified episodes of care into separate categories for each severity category of said diagnosed health condition in each of said health-cost risk groups;
trimming and combining the data in the same or a comparable manner as accomplished for the overall population of providers in calculating the relative-cost factors;
summing that provider's actual costs for all qualified episodes of care for each of that provider's diagnosed health conditions in each severity category and in each of said health-risk cost groups and dividing by the sum of the corresponding expected cost per qualified episode of care for each of said diagnosed health conditions in each severity category and in each of said health-risk cost groups to compute a provider's RACI; and
when said provider cost-effectiveness ratio is less than or equal to a predetermined value, storing identity information for said provider in a first memory location, and when said provider cost-effectiveness ratio is greater to said predetermined value, not storing identity information for said provider in said first memory location.
